(19) United States
(12) Patent Application Publication
(10) Pub. No.: US 2026/0356508 A1
(43) Pub. Date: Nov. 12, 2026

(54) Recursive Predictive Forecasting Equation for Chaotic Orbital and Dynamic Energy Systems

(71) Applicant: Adam L McEvoy, Omaha, NE (US)

(72) Inventor: Adam L McEvoy, Omaha, NE (US)

(21) Appl. No.: 19/203,245

(22) Filed: May 9, 2025

(51) Int. Cl. B64G 99/00; G01C 21/24; G06F 17/11

(52) U.S. Cl. CPC B64G 99/00; G06F 17/11; G01C 21/24

(57) ABSTRACT

This invention introduces a recursive forecasting method for nonlinear dynamic systems, providing a deterministic solution to the chaotic three-body problem and similar systems. It predicts orbital curvature inflection points using a recursive equation scaled by phase oscillation and reference radii. The invention enables predictive control, orbital stabilization, and energy amplification across gravitational, mechanical, and chaos-driven systems. Applications include celestial navigation, chaos-informed energy systems, and systems designed for theoretical or experimental infinite energy harvesting via timing-based reinforcement of chaotic dynamics.

### CROSS-REFERENCE TO RELATED APPLICATIONS

Not applicable.

### TECHNICAL FIELD

This invention pertains to physics, control theory, and nonlinear system modeling. It specifically applies to gravitational chaos, multi-body prediction, energy systems using dynamic feedback, and recursive simulation engines.

### BACKGROUND OF THE INVENTION

The three-body problem lacks a general closed-form solution due to chaotic sensitivity. Most current approaches use high-computation numerical solvers or AI approximators that lack deterministic control. This invention departs by offering a recursive curvature-based formula that enables deterministic forecasting, with applications to orbital systems, energy feedback systems, and chaos-based mechanical prediction.

### SUMMARY OF THE INVENTION

The invention introduces a recursive system that models orbital curvature evolution through a phase-scaled sinusoidal function, enabling long-term prediction of chaotic events in dynamic systems. It applies equally to three-body celestial mechanics, chaos-coupled pendulum networks, and systems designed to amplify energy through synchronized injection aligned with predictive curvature inflections.

### DETAILED DESCRIPTION OF THE INVENTION

### Core Recursive Formula (Claimed Invention)

The core recursive formula of the claimed invention is:

κₙ₊₁(t+Δt)=κₙ(t)×(1+α×sin(π×rₙ(t)/R_{ref}))

### Where:

κ(t): Orbital curvature or analogous trajectory inflection at time t
α: Amplification gain coefficient
rₙ(t): Radius or state variable at recursive step n
R_{ref}: Reference radius (dynamically scaled)
Δt: Recursive forecast time step

### Procedure for Chaotic System Forecasting

For the Three-Body Problem:
Initialize:
   Positions r₁, r₂, r₃; Velocities v₁, v₂, v₃; Masses m₁, m₂, m₃; Δt; G
Iterate per time step n:
   Compute pairwise forces: Fᵢ=Σ_{j≠i}G×mᵢ×mⱼ×(rⱼ−rᵢ)/|rⱼ−rᵢ|³
   Update accelerations aᵢ=Fᵢ/mᵢ
   Update positions and velocities via Verlet or velocity-Verlet integration
   Apply curvature update using recursive formula

### Worked Example (Simplified)

Using masses of 1.0, circular orbits, α=0.05, and R_{ref}=1.0, the system maintains periodic orbits with chaos-predictive correction and shows stable energy profiles when coupled with energy reinforcement logic.

### Statement of Novelty and Inventive Step

This invention represents a novel deterministic recursive forecasting model that allows prediction and control of chaotic systems using phase-based curvature logic. It contrasts sharply with brute-force integrators or neural approximators by offering a replicable, general-purpose mechanism usable in physical and simulated systems.

### Application Scope

This invention applies to, but is not limited to:
Multi-body gravitational prediction
Orbital stabilization and satellite path planning
Chaos-tuned kinetic reinforcement systems
Energy harvesting or amplification from oscillatory systems
Fractal control engines
Systems with feedback correction aligned with recursive curvature forecasting

### Filing Purpose

This application constitutes a full utility patent submission for intellectual property protection. It defines both the recursive method and its applications in chaos control, orbital prediction, and lawful energy feedback/amplification.

### Supporting Work

Full supporting evidence, simulations, and data are publicly archived:
https://zenodo.org/records/15291779
https://zenodo.org/records/15371160

This includes tests across chaotic mechanical systems (double pendulum, Duffing oscillator, triple pendulum) showing predictive stabilization and energy gain through minimal correction.

What is claimed is:

1. A recursive method for forecasting orbital or dynamic system inflection points, comprising:
(a) receiving initial state parameters including positions, velocities, and masses of bodies in a dynamic system;
(b) computing a curvature value κₙ(t) at a current time step;
(c) applying a recursive formula κₙ₊₁(t+Δt)=κₙ(t)×f(rₙ(t), R_{ref}, α), wherein f is a nonlinear scaling function involving phase, curvature, or radius; and
(d) outputting a predicted curvature value for a future time step based on said recursive formula.

2. The method of claim 1, wherein the nonlinear scaling function f comprises:
f(rₙ(t), R_{ref}, α)=1+α×sin(π×rₙ(t)/R_{ref})
wherein α is an amplification gain coefficient and R_{ref} is a dynamically scaled reference radius.

3. The method of claim 1, applied to gravitational N-body systems, comprising predictive correction of orbital curvature in a three-body gravitational system.

4. The method of claim 1, wherein said method is used for orbital stabilization, long-term prediction of inflection points, and entropic cycle prediction in celestial systems.

5. The method of claim 1, applied to chaos-driven pendulum or mechanical systems, enabling targeted energy injection based on predicted amplification cycles.

6. A deterministic prediction engine for dynamic systems, comprising:
(a) a processor configured to execute instructions;
(b) a memory storing instructions that, when executed by the processor, cause the processor to:
(i) receive state parameters of a chaotic dynamic system;
(ii) apply recursive curvature estimation using a nonlinear scaling function to reduce chaos, stabilize motion, or amplify energy; and
(iii) output predicted system states for future time steps.

7. The method of claim 1, wherein said method is applied in systems designed for energy amplification or phase-reinforced motion, including energy-harvesting systems that use predictive timing to efficiently recycle or amplify energy within physical constraints.

8. A computer-implemented method comprising implementing the recursive prediction system of claim 1 in at least one of: control systems, simulation engines, or energy feedback loops for prediction or control purposes.
